(19) United States
(12) Patent Application Publication
(10) Pub. No.: US 2009/0235529 A1
(43) Pub. Date: Sep. 24, 2009

(54) Hair cutting device

(75) Inventors: Yigal Natan Ringart, Givat-Ela (IL); Jacky Gamliel, Beverly Hills, CA (US); George W. Schaeffer, Beverly Hills, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Carmel International Corporation

(21) Appl. No.: 12/077,883

(22) Filed: Mar. 20, 2008

(51) Int. Cl. B26B 21/12; B26B 21/40; B26B 27/00

(52) U.S. Cl. 30/30; 30/539; 30/298

(57) ABSTRACT

A relatively inexpensive, single use, single edge hair cutting device. The device includes a handle portion, typically made of plastic, and an integral blade holding portion for holding a single edge blade used to cut hair. A detachable blade protector covers the blade prior to initial use of the device. In addition, finger portions extend over the blade leaving an edge exposed for cutting hair, while providing protection against cutting of the skin. The handle portion includes a finger grip, and loop, so that the handle can be held in the hand in a comfortable position while being used to cut hair.

### BACKGROUND OF THE INVENTION

The invention is directed to the field of hand operated hair cutting implements. Such hair cutting implements include scissors which, as is well known, include two cutting blades connected at a pivot point and which are manipulated by a hair cutting stylist by an opening and closing hand motion. A second type of hair cutting implement is in the nature of a single blade which is also a hand operated device. The device is manipulated by hand motions of a hair stylist to press the blade against the hair causing the hair to be cut when pressed against the sharp edge of the single blade. Other devices which may be used include electrically operated hair cutters, but the invention is directed specifically to single edge, hand operated razor blades.

In all cases it is desirable, and, in many situations required, to sanitize the cutting device between each customer of the hair stylist. In most single bladed razors used, there is an inability to replace the blade. Therefore, such razors should be sanitized after each use. Additionally, over time, the cutting edge of the blade of the cutting device becomes dull, and requires sharpening, or replacement for efficient operation. Additionally, although less of a problem when a scissors is utilized since the sharp edge of the blade is normally not exposed, when using a single blade razor device, extra caution must be taken to be sure that the sharp edge of the blade does not cut the skin of the customer. For this reason, although a single edge blade generally provides the hair stylist with various approaches relating to cutting direction options since it generally can be manipulated for certain types of cuts, and can be used to cut hair at the skin level, special added precautions must be taken when using the single edge blade. Further, higher levels of disinfecting are required due to the higher possibility of the blade cutting the skin of a customer leading to the possibility of infectious agents being transferred from one customer to another, or from a customer to the hair stylist.

In some single blade hair cutting razors used by hair stylists, the cutting blade can be replaced in lieu of the sanitizing operation. The blade replacement in front of the customer transfers a hygienic and fresh attitude although the blade-holder, which is reused and rarely replaced, is also a contaminated tool which is usually not disinfected.

Hair cutting by use of a single blade is described with reference to the following terms with reference to FIGS. 5 and 6.

Blade edge angle 101—a symmetric angle created by grinding of both sides of the parallel “blade body” 102) surfaces thru the blade edge (looking at a cross sectional view of the blade) to produce a polish finish.

Cutting angle 103—an angle created between the blade center line and the tangent of skin in contact (looking at a cross sectional view of the blade).

Parallel safety distance 104—a distance between the skin and the blade edge enabling hair cutting without skin damage. The distance is needed for free skin deflection. It is measured from the skin to the blade body surface at the grinding start point when looking at a cross sectional view of the blade.

Perpendicular safety distance 105—a distance created by a set of fingers or teeth extension on top of the cutting edge and the skin surface ensuring no skin is cut while moving the blade along its longitudinal axis while maintaining the contact with the skin. The distance is needed for free skin deflection. It is measured from the skin tangent to the blade edge. Typically, a sufficient distance is about 0.4-0.8 mm, looking at a cross sectional view of the blade.

Exposure safety ratio—a ratio calculated by dividing the distance between every two fingers 106 extending over the blade and the perpendicular safety distance ensuring no skin is cut while moving the blade along its longitudinal axis maintaining contact with the skin. A sufficient ratio is about 8:1 or less.

A smoother and safer single edge hair cut is created by moving the cutting device (having a blade) along the blade width center line towards its edge direction in a cutting angle as close as possible to the half of the blade edge angle while maintaining the parallel safety distance.

### BRIEF SUMMARY OF THE INVENTION

A relatively inexpensive, single use, single edge hair cutting device is disclosed. The device includes a handle portion, typically made of plastic, and an integral blade holding portion for straight holding of a single edge metal blade used to cut hair. In addition, symmetrical plastic molded finger portions extend over both sides of the blade to provide a parallel safety distance and on top of the blade to provide a perpendicular safety distance leaving an edge exposed for cutting hair, while providing protection against cutting of the skin. This enables an unfettered right or left handed approach for smooth and safe hair cutting ability.

An integral but detachable blade protector keeps the blade unharmed prior to initial use of the device.

The handle portion includes a finger grip, and loop, so that the handle can be held in the hand in a comfortable position while being used to cut hair.

### BRIEF DESCRIPTION OF THE DRAWINGS

FIG. 1 is a side elevation view of a razor device according to the present invention.

FIG. 2 is a front bottom perspective view of the invention.

FIG. 3 is a front bottom perspective view of the invention with blade protector detached.

FIG. 4 shows a package which may be used to contain the razor device prior to its initial use.

FIG. 5 is a expanded sectional view of the blade portion of the razor device.

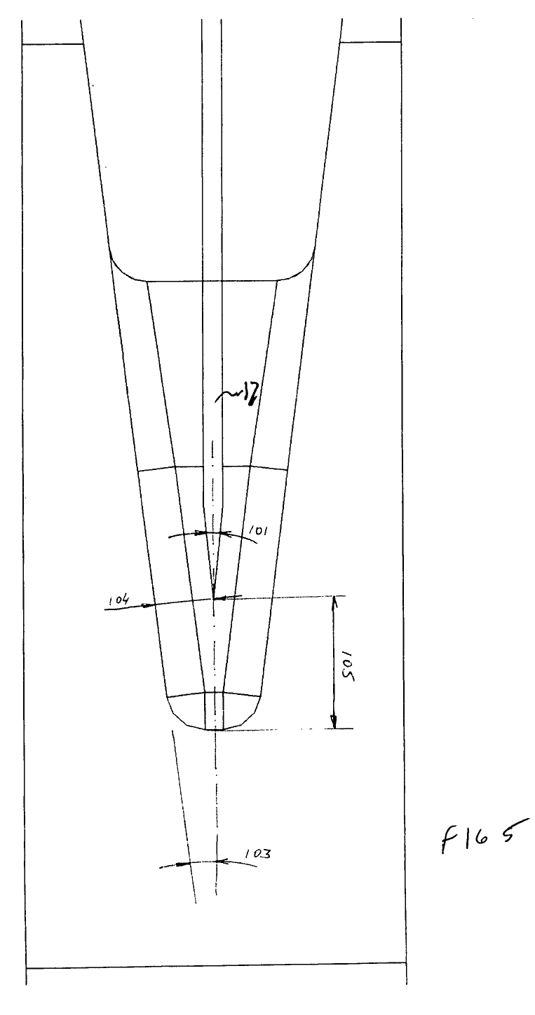

FIG. 6 an expanded view of a portion of the razor device with blade protector.

### DETAILED DESCRIPTION OF THE INVENTION

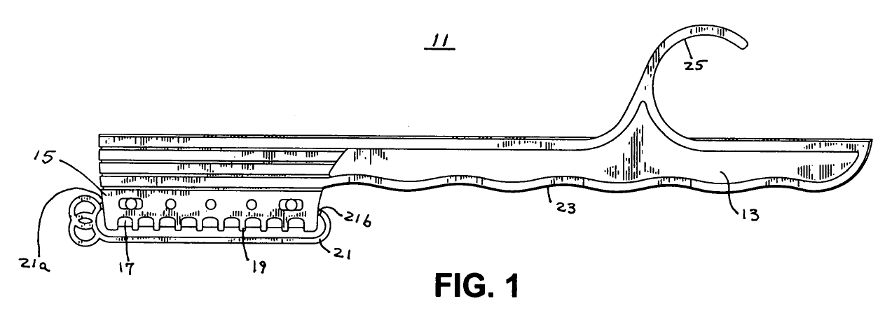

Referring first to FIG. 1, a hair cutting device 11 is shown. The device includes an elongated handle portion 13. Integral with the handle portion is a blade holding portion 15. A blade 17 is embedded within one edge of the blade holding portion 15. The blade holding portion also includes protective fingers 19 which extend over the blade while still leaving portions of the blade exposed. The handle, the blade holding portion and the blade lie substantially in one plane. A detachable blade protector 21 which is integral with blade holding portion 15 provides protection to the blade until its initial use, before which blade protector 21 is removed as explained below.

Handle portion 13 also includes at one edge finger grasping portion 23 in the nature of shallow indentations against which the fingers of an operator of the device can rest. At the other edge of the handle a finger loop 25 is formed typically in to which the ring finger of the operator of the device may be inserted in order to provide additional leverage while operating the device.

A detachable blade protector 21 includes portions 21A and 21B forming two attachment locations which are thinner than the remaining portions of the blade protector. Additional attachment locations may be added. In this manner, when holding the device in one hand, and grasping the blade protector 21 in the second hand, a slight twisting movement will cause the portions 21A and 21B to break, thereby enabling the blade protector to be removed.

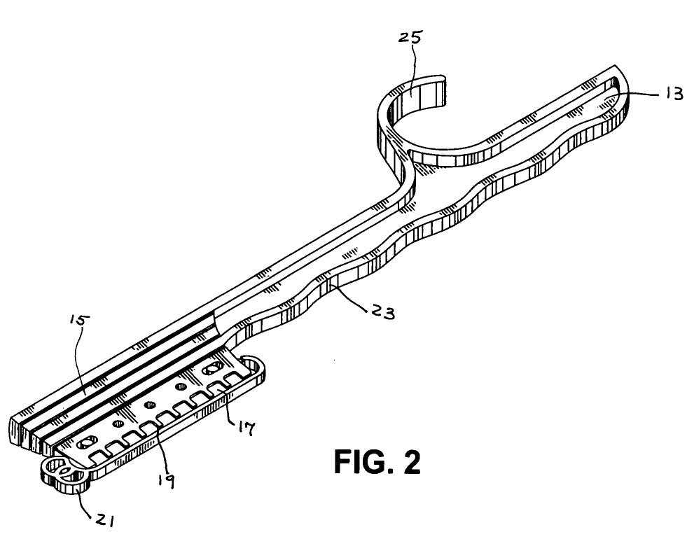

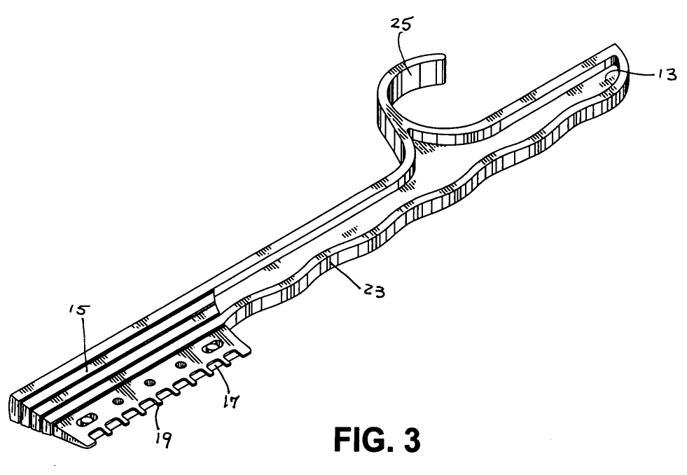

Further details regarding the hair cutting device and its operation will now be described with reference to FIGS. 2 and 3. As best seen in FIG. 2, although handle 13 has essentially the same thickness at its two edges, blade holding portion 15 tapers from its edge opposite the blade to provide extra strength by being thicker at one edge, tapering from this one edge to be relatively thin at its opposite edge having the exposed blade edge. In another aspect, along both ends of the blade, the holding portion covers the sharp corners of the metal blade protecting from possible skin injury.

Protective fingers 19 extend over both sides of the blade starting from the blade “body surface” at a distance of 0.1 to 0.9 mm which enables safe contact with the skin thus allowing the skin needed deflection. The fingers' shape allows the operator the ability to maintain a minimal cutting angle needed for a smooth hair cut at both a left or right hand side approach without possible damage to the skin by virtue of the parallel safety distance. However, there are relatively wide gaps over the blade top so that the sharp blade edge between the fingers leaves sufficient blade edge exposure to enable efficient cutting of the hair. Another aspect of the fingers' exposure is maintaining the perpendicular safety distance of 0.2 to 0.5 mm relative height and an exposure safety ratio on the order of 7:1. FIG. 3 shows the hair cutting device after the blade protector 21 has been removed.

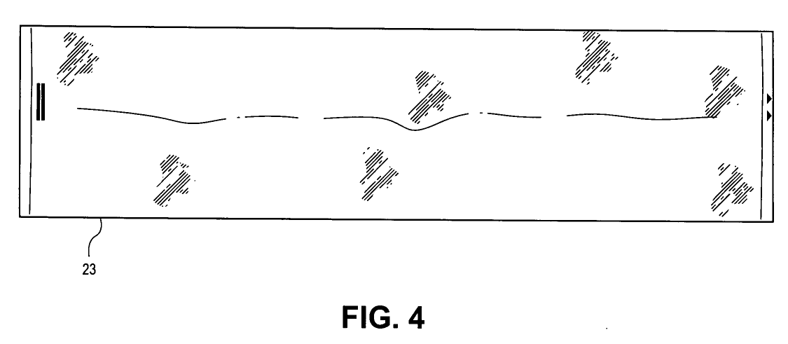

The hair cutting device is intended to be used one time, for a single customer of the hair stylist. In this connection, before initial use of the device, the device is enclosed within a small package 23 shown in FIG. 4. Although not necessarily sterile, the device is designed and manufactured without being touched by any person, and then enclosed in the package so that the first time the device is exposed to a human touch is when the package is opened prior to initial use of the device. In this manner, there is a high level of confidence that the hair cutting device is completely clean since the customer can see the device being removed from the package just prior to its initial use.

After removal from the package, blade protector 21 is removed as explained above. The device is then held by the hair stylist in one hand and is used to cut hair using essentially the same techniques as are used for cutting hair using a prior art single blade razor having better safety against skin injury with no influence regarding the hair cut quality. The finger grip portions and finger loop allow the hair stylist to obtain additional leverage while operating the device. Due to the inexpensive nature of the device, after using it to cut the hair of a single customer, it may be discarded.

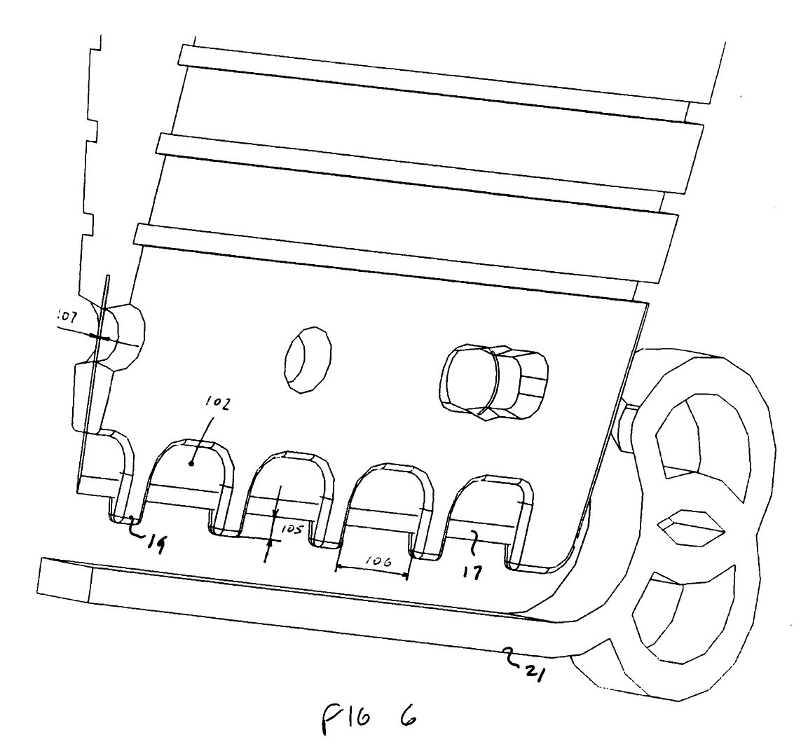

The device may be manufactured using a prior art single stage injection molding technique in which the blade is inserted into the mold so that the handle, blade holder and blade protector are formed so that these elements form a single integral unit encompassing the blade. The blade holding portion has at least one double side touch point over the blade thickness along the opposite side of the cutting edge 107 (see FIG. 6) for maintaining the blade straight during the molding process. Using well known techniques, the finished product is enclosed within its packaging as part of the manufacturing process so that the product is never touched by a person during the entire process.

What is claimed is:

1. A razor device comprising:
a) a handle portion configured to be grasped by a hand of a user;
b) a blade holding portion formed integral with said handle portion and disposed adjacent to one end of said handle portion, said blade holding portion including a cutting blade, said handle portion, said blade holding portion and said blade lying substantially in one plane;
c) a plurality of finger portions integral with said blade holding portion, said finger portions extending over a cutting edge of said cutting blade.

2. The device of claim 1 wherein said handle portion includes an integral partial loop disposed at an opposite side of said handle portion relative to said blade holding portion between said one end and a second end of said handle portion.

3. The device of claim 1 further comprising a break-away blade protector formed integral with said blade holding portion extending a length of said blade, forming a protective barrier over said blade and configured to be detachable from said blade holding portion.

4. The device of claim 1 wherein said break-away blade protector is attached to said blade holding portion at least one location, which attachment is disposed at opposite ends of said blade holding portion, wherein at each of said at least one attachment locations, the blade protector is thinner than remaining portions of said blade protector.

5. The device of claim 1 wherein said handle portion and said blade holding portion are formed using a single stage molding operation over the metal blade using a plastic material.

6. The device of claim 1 wherein said blade holding portion forms a taper beginning at a side opposite said finger portions extending to said finger portions

7. The device of claim 1 wherein said blade holding portion forms double side taper finger portions allowing an unfettered right or left handed approach for hair cutting.

8. The device of claim 1 wherein said blade holding portion forms exposed fingers with free cutting edge in between, and maintains an exposure safety ratio of less than approximately 8:1.

9. The device of claim 1 further comprising a package adapted to contain said razor device prior to an initial use.

10. The device of claim 1 wherein said blade holding portion having at least one double side touch point over the blade thickness along the opposite side of the cutting edge for maintaining the blade straight during the molding forming process.
